(19) United States
(12) Patent Application Publication
(10) Pub. No.: US 2025/0261799 A1
(43) Pub. Date: Aug. 21, 2025

(54) KITCHEN STAND MIXER AND SHAFT HEIGHT ADJUSTMENT MECHANISM FOR A KITCHEN STAND MIXER

(71) Applicant: Haier US Appliance Solutions, Inc., Wilmington, DE (US)

(72) Inventors: Danister Abeygunawardana, Jeffersonville, IN (US); Tomas Garces, Louisville, KY (US)

(21) Appl. No.: 18/442,801

(22) Filed: Feb. 15, 2024

(51) Int. Cl. A47J 43/044; A47J 43/08

(52) U.S. Cl. CPC A47J 43/044; A47J 43/082; A47J 2043/04472; A47J 2043/0449

(57) ABSTRACT

A shaft adjustment assembly for a domestic appliance, the domestic appliance comprising a drive shaft, the shaft adjustment assembly includes an output shaft adjustably coupled to the drive shaft and including a chuck protrusion extending therefrom; a clutch cover positioned around the output shaft, the clutch cover being movable along the axial direction; at least one clutch pin operably coupled with the clutch cover, the at least one clutch pin selectively penetrating each of the drive shaft and the output shaft; a chuck sleeve positioned around the chuck protrusion, the chuck sleeve being movable with respect to the chuck protrusion; and a catch received within the chuck protrusion, the catch being movable between an engaged position and a recessed position.

### FIELD OF THE INVENTION

The present subject matter relates generally to domestic appliances, and more particularly to shaft adjustment assemblies for stand mixers.

### BACKGROUND OF THE INVENTION

Stand mixers are generally used for performing automated mixing, churning, or kneading involved in food preparation. Typically, stand mixers include a motor configured to provide torque to one or more driveshafts. Users may connect various utensils to the one or more driveshafts, including whisks, spatulas, or the like. In performing operations, multiple different utensils may be frequently switched. Each utensil may be a different height, resulting in different depth to which each utensil may extend within a bowl, for example.

Existing mixers exhibit certain drawbacks. For instance, adjusting a height (or depth) of a particular utensil is cumbersome and time consuming. Additional accessories or manipulation of the mixer can be required in order to achieve a desired depth of the utensil.

Accordingly, a stand mixer that obviates one or more of the above-mentioned drawbacks would be beneficial. In particular, a shaft adjustment assembly for a stand mixer capable of fine tuning would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a stand mixer is provided. The stand mixer may include a casing including a base, a column extending from the base, and a motor housing connected to the column; a motor assembly provided within the motor housing, the motor assembly including a motor shaft; a drive shaft operably coupled with the motor shaft and configured to receive a rotational input from the motor shaft; and a shaft adjustment assembly provided at a distal end of the drive shaft, the shaft adjustment assembly defining an axial direction, a radial direction, and a circumferential direction. The shaft adjustment assembly may include an output shaft adjustably coupled to the drive shaft along the axial direction and configured to receive a rotational input from the drive shaft, the output shaft including a chuck protrusion extending therefrom, the chuck protrusion being configured to receive one or more accessories; a clutch cover positioned around the output shaft along the circumferential direction, the clutch cover being movable along the axial direction between a first position and a second position; at least one clutch pin operably coupled with the clutch cover, the at least one clutch pin selectively penetrating each of the drive shaft and the output shaft along the axial direction; a chuck sleeve positioned around the chuck protrusion, the chuck sleeve being movable along the axial direction with respect to the chuck protrusion; and a catch received within the chuck protrusion, the catch being movable along the radial direction between an engaged position and a recessed position.

In another exemplary aspect of the present disclosure, a shaft adjustment assembly for a domestic appliance is provided. The domestic appliance may include a drive shaft, the shaft adjustment assembly being provided at a distal end of the drive shaft, the shaft adjustment assembly defining an axial direction, a radial direction, and a circumferential direction. The shaft adjustment assembly may include an output shaft adjustably coupled to the drive shaft along the axial direction and configured to receive a rotational input from the drive shaft, the output shaft including a chuck protrusion extending therefrom, the chuck protrusion being configured to receive one or more accessories; a clutch cover positioned around the output shaft along the circumferential direction, the clutch cover being movable along the axial direction between a first position and a second position; at least one clutch pin operably coupled with the clutch cover, the at least one clutch pin selectively penetrating each of the drive shaft and the output shaft along the axial direction; a chuck sleeve positioned around the chuck protrusion, the chuck sleeve being movable along the axial direction with respect to the chuck protrusion; and a catch received within the chuck protrusion, the catch being movable along the radial direction between an engaged position and a recessed position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side section view of a stand mixer according to an exemplary embodiment of the present disclosure.

FIG. 2 provides a perspective close up view of a shaft adjustment assembly of the stand mixer of FIG. 1 according to exemplary embodiments of the disclosure.

FIG. 3 provides a cross-section view of the exemplary shaft adjustment assembly of FIG. 2.

FIG. 4 provides a closeup cross-section view of the exemplary shaft adjustment assembly of FIG. 2 with a clutch cover in a first position.

FIG. 5 provides a closeup cross-section view of the exemplary shaft adjustment assembly of FIG. 2 with the clutch cover in a second position.

FIG. 6 provides a perspective view of an interior of the exemplary shaft adjustment assembly of FIG. 2.

FIG. 7 provides a perspective cross-section view of the exemplary shaft adjustment assembly of FIG. 2 with the clutch cover in the second position.

FIG. 8 provides a partial perspective cross-section view of the exemplary shaft adjustment assembly of FIG. 2 with the clutch cover in the second position.

FIG. 9 provides a closeup cross-section view of a sleeve of the exemplary shaft adjustment assembly of FIG. 2 in a locked position.

FIG. 10 provides a closeup cross-section view of the sleeve of the exemplary shaft adjustment assembly of FIG. 2 in an unlocked position.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

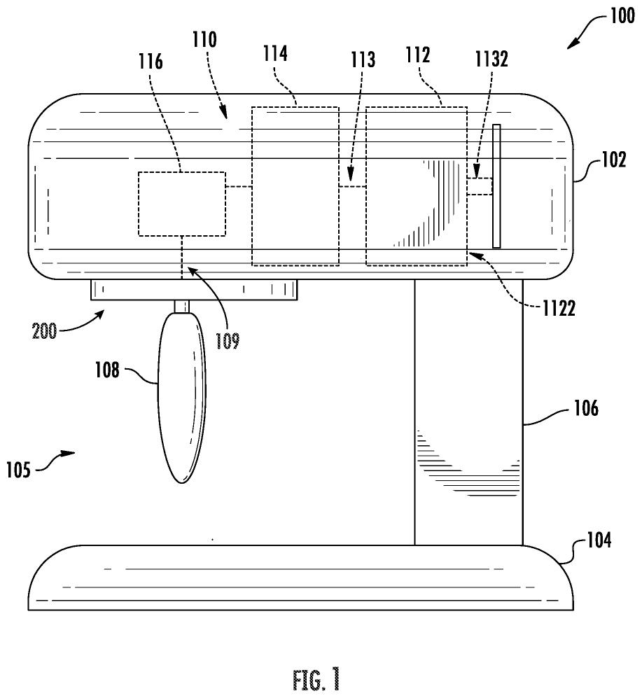

FIG. 1 provides a side view of a stand mixer 100 according to an exemplary embodiment of the present subject matter. It will be understood that stand mixer 100 is provided by way of example only and that the present subject matter may be used in or with any suitable stand mixer in alternative example embodiments. Moreover, with reference to FIG. 1, stand mixer 100 defines a vertical direction V, a lateral direction L, and a transverse direction T. It should be understood that these directions are presented for exemplary purposes only, and that relative positions and locations of certain aspects of stand mixer 100 may vary according to specific embodiments, spatial placement, or the like.

Stand mixer 100 may include a casing 101. In detail, casing 101 may include a motor housing 102, a base 104, and a column 106. Motor housing 102 may house various mechanical and/or electrical components of stand mixer 100. For example, as shown in FIG. 1, a motor 112, a planetary gearbox (or reduction gearbox) 114, and a bevel gear box 116 may be disposed within motor housing 102. Base 104 may support motor housing 102. For example, motor housing 102 may be mounted (e.g., pivotally) to base 104 via column 106, e.g., that extends upwardly (e.g., along the vertical direction V). Motor housing 102 may be suspended over a mixing zone 105, within which a mixing bowl may be disposed.

A drivetrain 110 may be provided within motor housing 102 and is configured for coupling motor 112 to a shaft 109 (e.g., a mixer shaft or drive shaft), such that shaft 109 is rotatable via motor 112 through drivetrain 110. Drivetrain 110 may include planetary gearbox 114, bevel gearbox 116, etc. Drive shaft 109 may be positioned above mixing zone 105 on motor housing 102, and an attachment 108, such as a beater, whisk, or hook, may be removably mounted to drive shaft 109. Attachment 108 may rotate within a bowl (not shown) in mixing zone 105 to beat, whisk, knead, etc. material within the bowl, during operation of motor 112.

As noted above, motor 112 may be operable to rotate drive shaft 109. For instance, a motor shaft 113 may connect motor 112 to drive shaft 109 (e.g., through planetary gearbox 114, bevel gearbox 116, etc.). Motor 112 may be a direct current (DC) motor in certain example embodiments. In alternative example embodiments, motor 112 may be an alternating current (AC) motor. Motor 112 may include a rotor and a stator. The stator may be mounted within motor housing 102 such that the stator is fixed relative to motor housing 102. A current through windings within the stator may generate a magnetic field that induces rotation of the rotor, e.g., due to magnets or a magnetic field via coils on the stator. The rotor may rotate at a relatively high rotational velocity and relatively low torque. Thus, drivetrain 110 may be configured to provide a rotational speed reduction and mechanical advantage between motor 112 and drive shaft 109.

Stand mixer 100 may include a shaft adjustment assembly 200. Shaft adjustment assembly 200 may be provided at a distal end of drive shaft 109. For instance, shaft adjustment assembly 200 may be operably connected with drive shaft 109. Shaft adjustment assembly 200 may be configured to provide height adjustments (e.g., along the vertical direction V) to attachment 108. For instance, shaft adjustment assembly 200 may allow for incremental height adjustments of attachment 108 relative to drive shaft 109. Shaft adjustment assembly 200 may define an axial direction A, a radial direction R, and a transverse direction T. According to some embodiments, axial direction A may be parallel with vertical direction V of stand mixer 100.

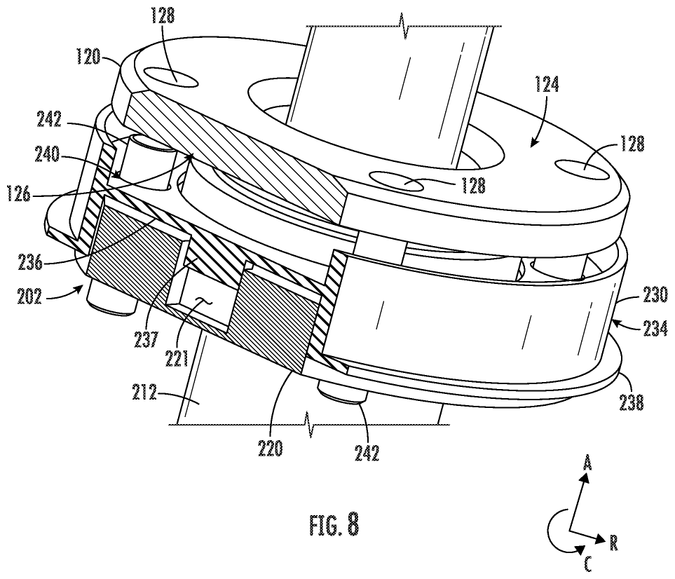

Referring briefly to FIGS. 5 and 8, a distal end 118 of drive shaft 109 is shown. Drive shaft 109 may be adjustably coupled to shaft adjustment assembly 200, as will be described. Drive shaft 109 may include a drive flange 120. Drive flange 120 may protrude from distal end 118 of drive shaft 109 along the radial direction R. For instance, drive shaft 109 may include an outer circumferential surface 122. Drive flange 120 may extend along the circumferential direction C, about drive shaft 109 along outer circumferential surface 122. Accordingly, drive flange 120 may include a top surface 124 (e.g., facing upward along the axial direction A) and a bottom surface 126 opposite top surface 124 (e.g., facing downward along the axial direction A). Additionally or alternatively, outer circumferential surface 122 of drive shaft 109 may be threaded. According to some embodiments, drive flange 120 is positioned above the threaded portion of drive shaft 109 (e.g., along the axial direction A).

At least one drive pin hole 128 may be formed through drive flange 120. In detail, a set of drive pin holes 128 may be defined through drive flange 120 along the axial direction A. Each of the set of drive pin holes 128 may extend through drive flange 120 from top surface 124 to bottom surface 126. Accordingly, drive pin holes 128 may be through holes. According to some embodiments, however, drive pin holes 128 may be blind holes. For instance, drive pin holes 128 may extend upward along the axial direction from bottom surface 126 to a blind portion within drive flange 120. Any suitable number of drive pin holes 128 may be provided through drive flange 120, such as 4 drive pin holes, 6 drive pin holes, 8 drive pin holes, or the like. Moreover, the set of drive pin holes 128 may be spaced equidistant from each other along the circumferential direction C about drive flange 120. As will be described in more detail below, drive pin holes 128 may be configured to selectively receive clutch pins therein.

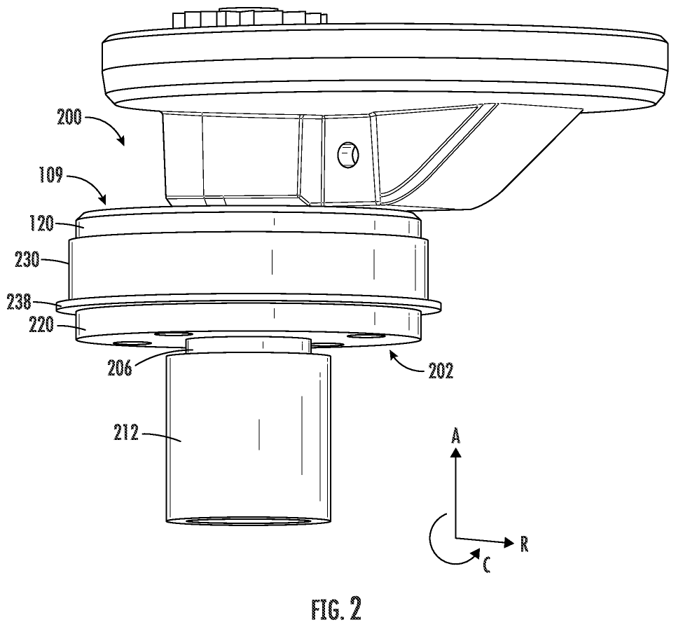

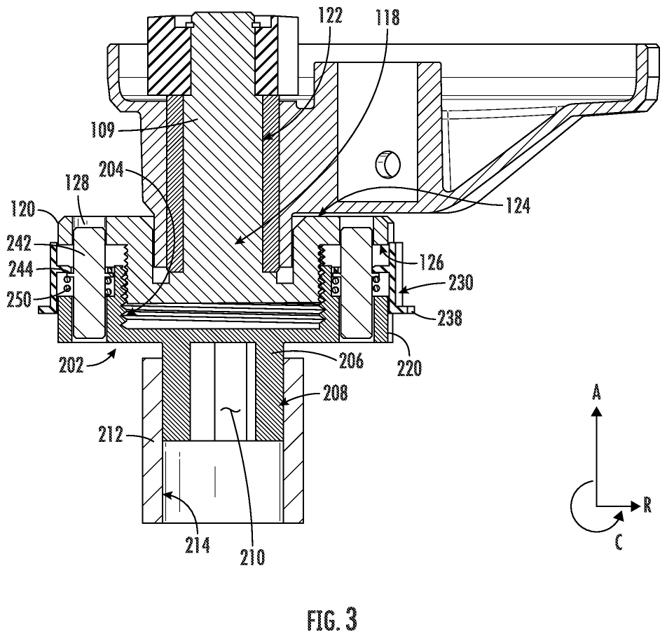

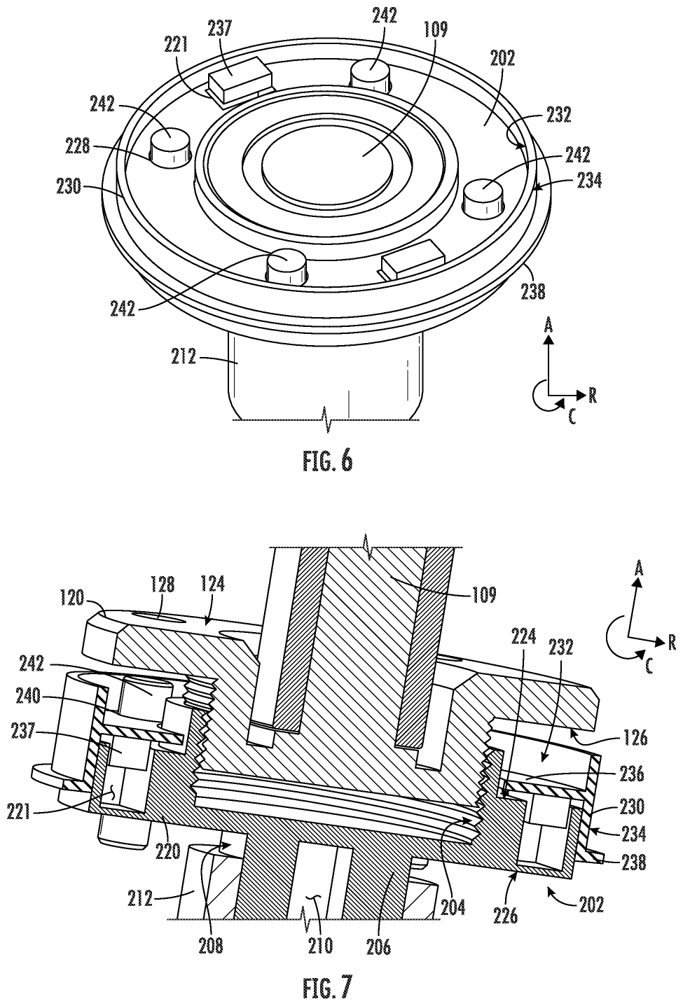

Referring now to FIGS. 2 through 10, shaft adjustment assembly 200 will be described in detail. Shaft adjustment assembly 200 may include an output shaft 202. Output shaft 202 may be operably connected with drive shaft 109. For instance, output shaft 202 may be threadedly coupled with drive shaft 109 (FIG. 3). Accordingly, output shaft 202 may be adjusted with respect to drive shaft 109 along the axial direction A by rotating about drive shaft 109. Output shaft 202 may be in threaded attachment with outer circumferential surface 122 of drive shaft 109. For instance, output shaft 202 may include an inner circumferential surface 204. Inner circumferential surface 204 may be threaded (e.g., complementary to outer circumferential surface 122 of drive shaft 109). Thus, output shaft 202 may be threaded onto drive shaft 109. However, according to some embodiments, output shaft 109 is in threaded attachment with an inner circumferential surface of drive shaft 109, as one of ordinary skill in the art would understand.

Output shaft 202 may thus receive a rotational input from drive shaft 109. In detail, as motor 112 provides rotational energy to motor shaft 113, the rotational energy may be transferred (e.g., through gearboxes 114, 116) to drive shaft 109. Drive shaft 109 may then rotate (e.g., about the circumferential direction C). As output shaft 202 is in threaded attachment with drive shaft 109 along the axial direction A, output shaft 202 may also rotate, in turn providing a rotational output to attachment 108 (e.g., within a mixing bowl). As mentioned above, motor 112 may be a bi-directional motor. Accordingly, each of drive shaft 109 and output shaft 202 may be configured to rotate in either a clockwise direction or a counterclockwise direction. As will be described, shaft adjustment assembly 200 may restrict output shaft 202 from unthreading from drive shaft 109.

Output shaft 202 may include a chuck protrusion 206. Chuck protrusion 206 may extend from a distal end of output shaft 202 (e.g., along the axial direction A). Thus, chuck protrusion 206 may extend away from drive shaft 109. Chuck protrusion 206 may be configured to receive one or more accessories (e.g., attachment 108, described above). Output shaft 202 (e.g., at chuck protrusion 206) may include an outer circumferential surface 208. Outer circumferential surface 208 may be predominantly cylindrical along the axial direction A. Moreover, chuck protrusion 206 may define an accessory receiving cavity 210. Accessory receiving cavity 210 may be a hexagonal cavity, for instance. However, it should be understood that receiving cavity 210 may have any suitable shape to accommodate a variety of accessories or attachments.

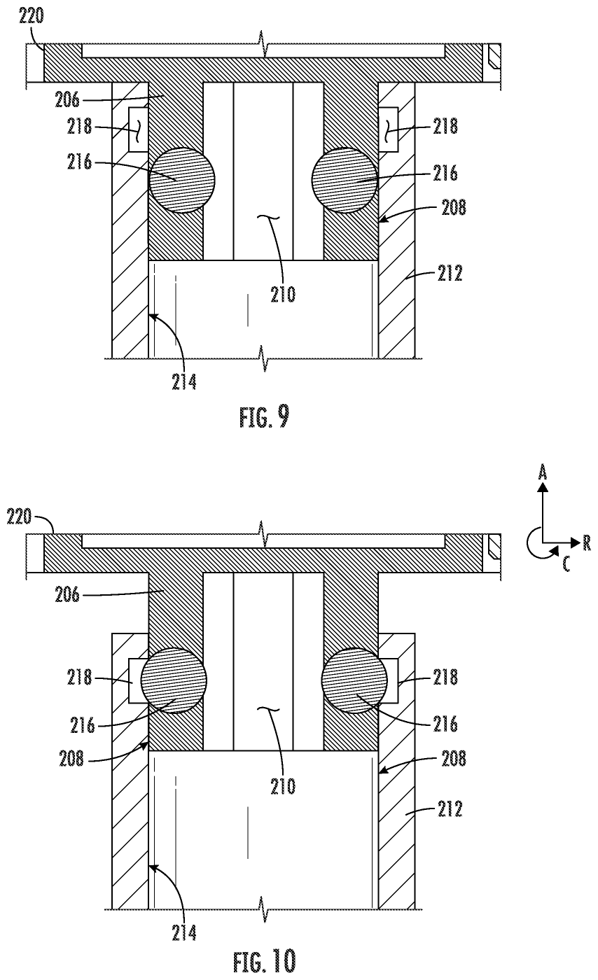

Shaft adjustment assembly 200 may include a chuck sleeve 212. Chuck sleeve 212 may be provided around chuck protrusion 206 (e.g., along the circumferential direction C). Chuck sleeve 212 may be movably coupled to chuck protrusion 206. For instance, chuck sleeve 212 may be in sliding contact (e.g., along the axial direction A) with outer circumferential surface 208 of chuck protrusion 206. Chuck sleeve 212 may include an inner circumferential surface 214. Accordingly, inner circumferential surface 214 may be in sliding contact with outer circumferential surface 208 of chuck protrusion 206. Chuck sleeve 212 may be slidable between a locked position (FIG. 9) and an unlocked position (FIG. 10). For instance, the locked position may refer to a position during which accessory 108 is attached to chuck protrusion 206. Accordingly, the unlocked position may refer to a position during which accessory 108 is released from chuck protrusion 206.

Referring briefly to FIGS. 9 and 10, chuck protrusion 206 may include a catch 216. In detail, a set of catches 216 may be provided within chuck protrusion 206. Hereinafter, a description of a single catch 216 will be provided in detail with the understanding that the description applies to two or more catches that may be incorporated into specific embodiments. Catch 216 may be a ball (e.g., a sphere) positioned within a groove formed within chuck protrusion 206. For instance, the groove may be formed through chuck protrusion 206 along the radial direction R. Catch 216 may be movable within chuck protrusion 206 (e.g., within the groove) along the radial direction between an engaged position (FIG. 9) and a recessed position (FIG. 10). Catch 216 may be restrained within the groove such that only a predetermined portion of catch 216 is able to protrude from chuck protrusion 206.

In the engaged position, at least a portion of catch 216 may protrude into receiving cavity 210 (e.g., along the radial direction R). When catch 216 is in the engaged position, the portion thereof within receiving cavity 210 may be received within a groove formed, for example, within accessory 108. Accordingly, accessory 108 may be locked into place within receiving cavity 210. When catch 216 is in the recessed position, no portion thereof is located within receiving cavity 210. Accessory 108 may then be removed from receiving cavity 210 (e.g., along the axial direction A).

Chuck sleeve 212 may include a groove 218. Groove 218 may be formed into inner circumferential surface 214 (e.g., along the radial direction R). As mentioned above, chuck sleeve 212 may be slidable between the locked position and the unlocked position. When chuck sleeve is in the unlocked position (FIG. 10), at least a portion of catch 216 may be received within groove 218 (e.g., along the radial direction R). For instance, as chuck sleeve 212 is moved (e.g., downward along the axial direction A), groove 218 becomes aligned with catch 216 along the radial direction R. Catch 216 may then move along the radial direction from receiving cavity 210 toward groove 218.

Referring back to FIGS. 2 through 8, output shaft 202 may include an output flange 220. Output flange 220 may protrude from a proximal end of output shaft 202 along the radial direction R. For instance, output shaft 202 may include outer circumferential surface 208. Output flange 220 may extend along the circumferential direction C, about output shaft 202 along outer circumferential surface 208. Accordingly, output flange 220 may include a top surface 224 (e.g., facing upward along the axial direction A) and a bottom surface 226 opposite top surface 224 (e.g., facing downward along the axial direction A). Additionally or alternatively, inner circumferential surface 204 of output shaft 202 may be threaded. According to some embodiments, output flange 220 is positioned above chuck protrusion 206 (e.g., along the axial direction A).

Output flange 220 may include a trench 221. Trench 221 may be formed through top surface 224 of output flange 220 (e.g., along the axial direction A). Trench 221 may have any suitable depth. For instance, trench 221 may be a blind hole formed into top surface 224. Any suitable number of trenches 221 may be formed. According to some embodiments, a plurality of trenches 221 are provided. Each of the plurality of trenches 221 may be spaced equidistant from each other about the circumferential direction C.

At least one output pin hole 228 may be formed through output flange 220. In detail, a set of output pin holes 228 may be defined through output flange 220 along the axial direction A. Each of the set of output pin holes 228 may extend through output flange 220 from top surface 224 to bottom surface 226. Accordingly, output pin holes 228 may be through holes. According to some embodiments, however, output pin holes 228 may be blind holes. For instance, output pin holes 228 may extend downward along the axial direction A from top surface 226 to a blind portion within output flange 220. Any suitable number of output pin holes 228 may be provided through output flange 220, such as 4 output pin holes, 6 output pin holes, 8 output pin holes, or the like. For instance, the number of output pin holes 228 may be equal to the number of drive pin holes 128. Moreover, the set of output pin holes 228 may be spaced equidistant from each other along the circumferential direction C about output flange 220. As will be described in more detail below, output pin holes 228 may be configured to receive clutch pins therein.

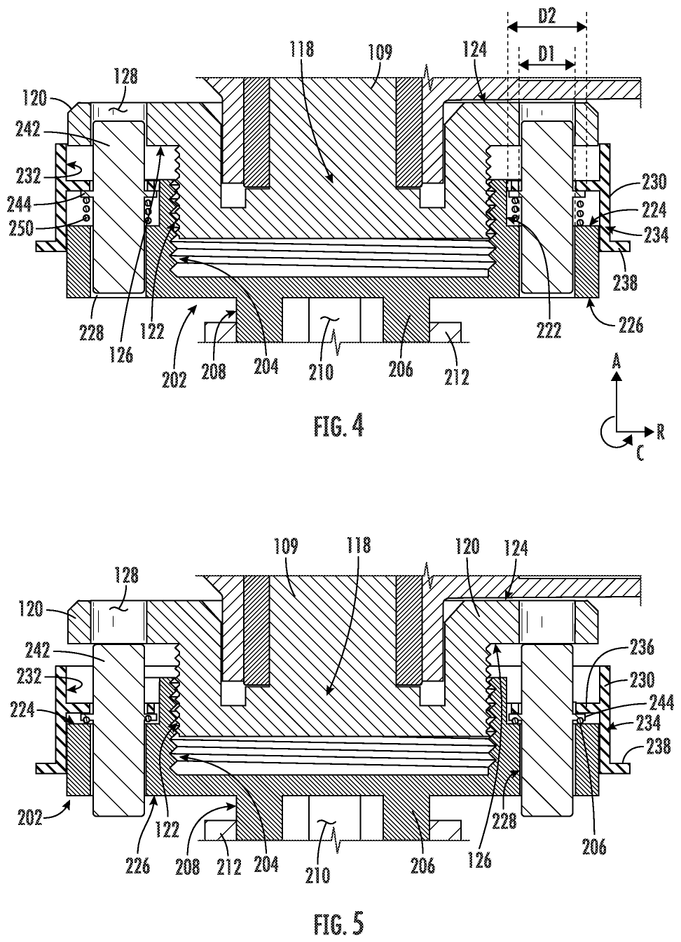

Shaft adjustment assembly 200 may include a clutch cover 230. Clutch cover 230 may be positioned around output shaft 202 (e.g., along the circumferential direction C). Clutch cover 230 may be generally cylindrically shaped and may include or define an inner circumferential face 232 and an outer circumferential face 234 opposite inner circumferential face 232. For instance, inner circumferential face 232 may be in contact with output shaft 202 (e.g., at output flange 220). Clutch cover 230 may be movable along the axial direction A. According to at least some embodiments, clutch cover 230 is movable between a first position (FIG. 4) and a second position (FIG. 5). Accordingly, inner circumferential face 232 may be in sliding contact with output flange 220.

Clutch cover 230 may include an inner flange 236. Inner flange 236 may protrude inward (e.g., along the radial direction R) from inner circumferential face 232. For instance, inner flange 236 may be positioned between output flange 220 and drive flange 120 (e.g., along the axial direction A). Inner flange 236 may extend along the circumferential direction C. A gap may be formed between a distal edge of inner flange 236 and output shaft 202. However, in some instances, inner flange 236 may contact outer circumferential surface 208 of output shaft 202. Additionally or alternatively, inner flange 236 may be positioned at or near a top of clutch cover 230 (e.g., along the axial direction A).

Inner flange 236 may include a boss 237. Boss 237 may protrude downward (e.g., along the axial direction A) from a bottom surface of inner flange 236. According to some embodiments, a plurality of bosses 237 are provided. Each of the plurality of bosses 237 may be spaced equidistant from each other about the circumferential direction C. Boss 237 may be selectively received within trench 221 in output flange 220 (e.g., when clutch cover 230 is moved to the second position).

Clutch cover 230 may include an outer flange 238. Outer flange 238 may protrude outward (e.g., along the radial direction R) from outer circumferential face 234. Outer flange 238 may be provided at a bottom of clutch cover 230 (e.g., along the axial direction A). Outer flange 238 may extend along the circumferential direction C. For instance, outer flange 238 may provide a lip, handle, ledge, or otherwise contact point for a user to move clutch cover 230 from the first position (FIG. 4) to the second position (FIG. 5).

At least one clutch pin hole 240 may be formed through inner flange 236. In detail, a set of clutch pin holes 240 may be defined through inner flange 236 along the axial direction A. Each of the set of clutch pin holes 240 may extend through inner flange 236 from a top surface to a bottom surface thereof. Accordingly, clutch pin holes 240 may be through holes. Any suitable number of clutch pin holes 240 may be provided through inner flange 236, such as 4 clutch pin holes, 6 clutch pin holes, 8 clutch pin holes, or the like. For instance, the number of clutch pin holes 240 may be equal to the number of drive pin holes 128 and output pin holes 228. Moreover, the set of clutch pin holes 240 may be spaced equidistant from each other along the circumferential direction C about inner flange 236. Clutch pin hole 240 may define a diameter D1. As will be described in more detail below, clutch pin holes 240 may be configured to receive clutch pins therein.

Shaft adjustment assembly 200 may include a clutch pin 242. In detail, a set of clutch pins 242 may be provided. Any suitable number of clutch pins 242 may be provided, such as 4 clutch pins, 6 clutch pins, 8 clutch pins, or the like. For instance, the number of clutch pins 242 may be equal to the number of drive pin holes 128, output pin holes 228, and clutch pin holes 240. Hereinafter, a description of a single clutch pin 242 will be described with the understanding that the description applies to two or more clutch pins 242 that may be incorporated into specific embodiments.

Clutch pin 242 may be a cylindrical body. Clutch pin 242 may be operably coupled with clutch cover 230. For instance, clutch pin 242 may penetrate inner flange 236 (e.g., through clutch pin hole 240). Additionally or alternatively, clutch pin 242 may penetrate output flange 220 (e.g., through output pin hole 228). Further still, clutch pin 242 may selectively penetrate drive flange 120 (e.g., through drive pin hole 128).

Clutch pin 242 may include a pin flange 244. Pin flange 244 may protrude from clutch pin 242 along the radial direction R. Moreover, pin flange 244 may extend along the circumferential direction C. Pin flange 244 may define a diameter D2. Diameter D2 of pin flange 244 may be greater than diameter D1 of clutch pin hole 240. Additionally or alternatively, pin flange 244 may be positioned between inner flange 236 of clutch cover 230 and output flange 220 (e.g., along the axial direction A). Accordingly, when clutch cover 230 moves from the first position to the second position, clutch pin 242 is pushed downward (along the axial direction A) by inner flange 236 pushing on pin flange 244.

As can be seen in FIG. 5, a top portion of clutch pin 242 may be withdrawn from drive pin hole 128 when clutch cover 230 is in the second position. When clutch pin 242 is withdrawn from drive pin hole 128, output shaft 202 may be rotated (e.g., via the threads) with respect to drive shaft 109. Advantageously, this may allow for fine height adjustment (e.g., along the axial direction A) of output shaft 202. As would be understood, when clutch pin 242 is reinserted into drive pin hole 128 (e.g., when clutch cover 230 is returned to the first position), output shaft 202 may be restricted from rotating with respect to drive shaft 109.

Shaft adjustment assembly 200 may include a resilient member 250. In detail, a set of resilient members 250 may be provided. Any suitable number of resilient members 250 may be provided, such as 4 resilient members, 6 resilient members, 8 resilient members, or the like. For instance, the number of resilient members 250 may be equal to the number of clutch pins 242, drive pin holes 128, output pin holes 228, and clutch pin holes 240. Hereinafter, a description of a single resilient member 250 will be described with the understanding that the description applies to two or more resilient members 250 that may be incorporated into specific embodiments.

Resilient member 250 may be a spring. For instance, resilient member 250 may be a coil spring positioned around clutch pin 242. Resilient member 150 may be positioned between pin flange 244 and top surface 224 of output flange 220. Resilient member 250 may bias clutch pin 242 along the axial direction A. For instance, resilient member 250 may bias clutch pin 242 toward drive shaft 109. Thus, when clutch cover 230 is in the first position (FIG. 4), resilient member 250 biases clutch pin 242 into drive pin hole 128.

According to the embodiments described herein, accessories for a stand mixer may be fine adjusted along the axial direction through a clutch mechanism. One or more pins may penetrate each of a drive shaft and an output shaft to restrict rotational movement of each relative to each other. When the clutch mechanism is moved from a locked (or first) position to an unlocked (or second) position, the one or more pins are withdrawn from the drive shaft, allowing the output shaft to rotate with respect to the drive shaft. By way of a threaded attachment, the output shaft may thus raise or lower by small increments. Returning the clutch mechanism to the first position (after aligning the one or more pins with corresponding receiving holes) locks the output shaft relative to the drive shaft, allowing rotational energy to be exchanged between the two.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A stand mixer comprising:
a casing comprising a base, a column extending from the base, and a motor housing connected to the column;
a motor assembly provided within the motor housing, the motor assembly comprising a motor shaft;
a drive shaft operably coupled with the motor shaft and configured to receive a rotational input from the motor shaft; and
a shaft adjustment assembly provided at a distal end of the drive shaft, the shaft adjustment assembly defining an axial direction, a radial direction, and a circumferential direction, the shaft adjustment assembly comprising:
an output shaft adjustably coupled to the drive shaft along the axial direction and configured to receive a rotational input from the drive shaft, the output shaft comprising a chuck protrusion extending therefrom, the chuck protrusion being configured to receive one or more accessories;
a clutch cover positioned around the output shaft along the circumferential direction, the clutch cover being movable along the axial direction between a first position and a second position;
at least one clutch pin operably coupled with the clutch cover, the at least one clutch pin selectively penetrating each of the drive shaft and the output shaft along the axial direction;
a chuck sleeve positioned around the chuck protrusion, the chuck sleeve being movable along the axial direction with respect to the chuck protrusion; and
a catch received within the chuck protrusion, the catch being movable along the radial direction between an engaged position and a recessed position.

2. The stand mixer of claim 1, wherein the drive shaft comprises a drive flange protruding along the radial direction therefrom and extending along the circumferential direction, the drive flange comprising at least one drive pin hole defined therethrough along the axial direction.

3. The stand mixer of claim 1, wherein the output shaft comprises an output flange protruding along the radial direction therefrom and extending along the circumferential direction, the output flange comprising at least one output pin hole defined therethrough along the axial direction.

4. The stand mixer of claim 3, wherein the output shaft is in threaded attachment with the drive shaft.

5. The stand mixer of claim 3, wherein the clutch cover comprises:
an inner flange protruding inward along the radial direction from an inner circumferential face of the clutch cover and extending along the circumferential direction; and
an outer flange protruding outward along the radial direction from an outer circumferential face of the clutch cover and extending along the circumferential direction.

6. The stand mixer of claim 5, wherein the clutch cover further comprises at least one clutch pin hole defined through the inner flange along the axial direction.

7. The stand mixer of claim 6, wherein the at least one clutch pin comprises a pin flange protruding along the radial direction therefrom and extending along the circumferential direction, wherein a diameter of the pin flange is greater than a diameter of the clutch pin hole defined through the inner flange of the clutch cover.

8. The stand mixer of claim 7, further comprising:
a resilient member positioned between the pin flange and the output flange along the axial direction, the resilient member biasing the at least one clutch pin along the axial direction toward the drive shaft.

9. The stand mixer of claim 1, wherein the chuck sleeve is slidable along the axial direction between a locked position and an unlocked position.

10. The stand mixer of claim 9, wherein the chuck sleeve comprises a cavity formed into an inner circumferential surface thereof, the cavity configured to selectively receive the catch therein when the catch is in the recessed position and the chuck sleeve is in the unlocked position.

11. A shaft adjustment assembly for a domestic appliance, the domestic appliance comprising a drive shaft, the shaft adjustment assembly being provided at a distal end of the drive shaft, the shaft adjustment assembly defining an axial direction, a radial direction, and a circumferential direction, the shaft adjustment assembly comprising:
an output shaft adjustably coupled to the drive shaft along the axial direction and configured to receive a rotational input from the drive shaft, the output shaft comprising a chuck protrusion extending therefrom, the chuck protrusion being configured to receive one or more accessories;
a clutch cover positioned around the output shaft along the circumferential direction, the clutch cover being movable along the axial direction between a first position and a second position;
at least one clutch pin operably coupled with the clutch cover, the at least one clutch pin selectively penetrating each of the drive shaft and the output shaft along the axial direction;
a chuck sleeve positioned around the chuck protrusion, the chuck sleeve being movable along the axial direction with respect to the chuck protrusion; and
a catch received within the chuck protrusion, the catch being movable along the radial direction between an engaged position and a recessed position.

12. The shaft adjustment assembly of claim 11, wherein the drive shaft comprises a drive flange protruding along the radial direction therefrom and extending along the circumferential direction, the drive flange comprising at least one drive pin hole defined therethrough along the axial direction.

13. The shaft adjustment assembly of claim 11, wherein the output shaft comprises an output flange protruding along the radial direction therefrom and extending along the circumferential direction, the output flange comprising at least one output pin hole defined therethrough along the axial direction.

14. The shaft adjustment assembly of claim 13, wherein the output shaft is in threaded attachment with the drive shaft.

15. The shaft adjustment assembly of claim 13, wherein the clutch cover comprises:
an inner flange protruding inward along the radial direction from an inner circumferential face of the clutch cover and extending along the circumferential direction; and
an outer flange protruding outward along the radial direction from an outer circumferential face of the clutch cover and extending along the circumferential direction.

16. The shaft adjustment assembly of claim 15, wherein the clutch cover further comprises at least one clutch pin hole defined through the inner flange along the axial direction.

17. The shaft adjustment assembly of claim 16, wherein the at least one clutch pin comprises a pin flange protruding along the radial direction therefrom and extending along the circumferential direction, wherein a diameter of the pin flange is greater than a diameter of the clutch pin hole defined through the inner flange of the clutch cover.

18. The shaft adjustment assembly of claim 17, further comprising:
a resilient member positioned between the pin flange and the output flange along the axial direction, the resilient member biasing the at least one clutch pin along the axial direction toward the drive shaft.

19. The shaft adjustment assembly of claim 11, wherein the chuck sleeve is slidable along the axial direction between a locked position and an unlocked position.

20. The shaft adjustment assembly of claim 19, wherein the chuck sleeve comprises a cavity formed into an inner circumferential surface thereof, the cavity configured to selectively receive the catch therein when the catch is in the recessed position and the chuck sleeve is in the unlocked position.
